(19) United States
(12) Patent Application Publication
(10) Pub. No.: US 2017/0289134 A1
(43) Pub. Date: Oct. 5, 2017

(54) METHODS AND APPARATUS FOR ASSESSING AUTHENTICATION RISK AND IMPLEMENTING SINGLE SIGN ON (SSO) USING A DISTRIBUTED CONSENSUS DATABASE

(71) Applicant: Ping Identity Corporation, Denver, CO (US)

(72) Inventors: John Thomas BRADLEY, Santiago RM (CL); David CHASE, Denver, CO (US); David WAITE, Denver, CO (US)

(73) Assignee: Ping Identity Corporation, Denver, CO (US)

(21) Appl. No.: 15/474,343

(22) Filed: Mar. 30, 2017

Related U.S. Application Data
(60) Provisional application No. 62/315,323, filed on Mar. 30, 2016.

(51) Int. Cl. H04L 29/06; G06F 17/30

(52) U.S. Cl. CPC H04L 63/0815; H04L 63/105; G06F 17/30283; H04L 63/1425; H04L 63/1433

(57) ABSTRACT

In some embodiments, a method includes receiving, from a client compute device and at a server, a request to access a resource. The request can include an identifier associated with the client compute device. The method can further include accessing risk information associated with the client compute device from an instance of a distributed database at the server using the identifier. The risk information is provided to the distributed database by a set of compute devices. Each compute device from the set of compute devices implements a different instance of the distributed database. The risk information can be analyzed to identify an access decision and a level of access to the resource can be granted to the client compute device based on the access decision.

### CROSS-REFERENCE TO RELATED APPLICATION

This application claims priority to and the benefit of U.S. Provisional Patent Application No. 62/315,323, filed Mar. 30, 2016 and titled “Methods And Apparatus For Single Sign On (SSO) Using A Distributed Consensus Database,” which is incorporated herein by reference in its entirety.

### BACKGROUND

Some known Internet devices use web-based single sign-on (SSO) tokens to access resources and services offered by numerous service providers (SP) in a federation. A single sign-on scheme can be implemented according to one or more standards to authorize the access of network (e.g., Internet) devices to relying servers in a federation. For example, the OAuth open standard allows some servers (e.g., identity provider (IdP) servers) in a federation to validate and provide identity tokens to networked devices while other servers or relying-party servers within the federation rely on the authentication process performed by an IdP server (e.g., as indicated by the identity tokens) to issue application tokens. One benefit of single sign-on systems is that users don't need to re-authenticate themselves every time they request services or resources from different SPs in the federation. For example, once a user or device has been successfully authenticated by an IdP server, the relying-party servers may rely on the identity token provided by the IdP server without requesting further credentials from the user before providing the user or device with resources or services.

While, the single sign-on scheme is effective, several vulnerabilities remain that may allow an attacker or an unauthorized user to gain unauthorized access to SPs based on reliance on no-longer-active authorizations by an IdP server. For example, while an identity token may expire, an application token associated with a specific SP server may remain active. Accordingly, while access to the federation by a user or device may be denied, the user or device may still be able to access a specific SP server using the application token for that SP server. Moreover, some known systems do not adequately share risk information about user devices between SPs. This leads to less informed authentication decisions at SPs.

Accordingly, a need exists for methods and apparatus for single sign-on using a distributed consensus database in which authentication, security and risk data is propagated among the servers in a federation with atomicity, consistency, isolation and durability (ACID) according to real-time or near real-time user activity and/or authorizing entities. Additionally or alternatively, a need exists for methods and apparatus to decrease the window of time in which SP servers have unsynchronized security data, authentication data, risk data and/or authorization data regarding a user's authentication.

### SUMMARY

In some embodiments, a method includes receiving, from a client compute device and at a server, a request to access a resource. The request can include an identifier associated with the client compute device. The method can further include accessing risk information associated with the client compute device from an instance of a distributed database at the server using the identifier. The risk information is provided to the distributed database by a set of compute devices. Each compute device from the set of compute devices implements a different instance of the distributed database. The risk information can be analyzed to identify an access decision and a level of access to the resource can be granted to the client compute device based on the access decision.

In some embodiments, instances of a distributed consensus database can be configured to be implemented across or throughout a set of service provider (SP) servers via a network operatively coupled to an identity provider (IdP) server and the SP servers. The SP server includes a processor and an instance of a distributed database. The instance of a distributed database stores risk information associated with a client compute device. The processor is configured to receive a request from a client compute device to access resources provided by the SP server. The processor is operatively coupled to the instance of the distributed database and configured to access the risk information associated with the client compute device. The processor analyzes the risk information and determines an access decision for the client compute device. Additionally, the processor is configured to grant (or revoke) access to the resources provided by the SP server to the client compute device based on the authentication information provided by the client compute device.

### BRIEF DESCRIPTION OF THE DRAWINGS

FIG. 1A is a schematic illustration of a distributed consensus system for eliciting authentication and executing identity assertion consensus among the constituent servers, and includes an identity provider server connected to SP servers and a client computing device via a network, according to an embodiment.

FIG. 1B is a message flow diagram of an example operation of the distributed consensus system of FIG. 1A, according to an embodiment.

FIG. 2 is an example of tables and fields included in a distributed consensus database, according to an embodiment.

FIG. 3 is a message flow diagram illustrating a method of determining an access response to an SP server and synchronizing user session attributes among the constituents of a distributed authorization and authentication consensus system, according to an embodiment.

FIG. 4 is a flow chart illustrating a method of generating a session object associated with a user identity and synchronizing user session attributes among the constituents of a distributed consensus system, according to an embodiment.

FIG. 5 is a flow chart illustrating a method of validating a session request from a client compute device to an SP server through a session object locally stored in the SP server, according to an embodiment.

FIG. 6 is a message flow diagram illustrating a method of determining an access response at an SP server based on risk assessment information from a distributed consensus databases, according to an embodiment.

### DETAILED DESCRIPTION

In some embodiments, a non-transitory processor-readable medium includes code to cause a processor (e.g., on an IdP server) to receive, from an SP server, a redirected client compute device request to access a target resource or service hosted by the SP server. The code can cause the processor to send an authentication request to the client compute device requesting access to the target resource or service hosted by the SP server. Accordingly, the client compute device can transmit authentication data to the IdP server with one or more authentication parameters in response the authentication request. Thereafter, the IdP server can execute an authentication process and alternatively or additionally perform an identity risk assessment based on one or more of the received authentication data or parameters.

The outputs of the authentication process, the identity risk assessment and/or the received authentication parameters can be used to update or generate an instance of a session object. The instance of the session object can include, for example, a single sign-on token, an SP identifier, an identity risk value, an authentication assertion, a user attribute assertion, an authorization assertion and/or other session related data. Moreover, the IdP server can execute an ACID transaction to update or insert one or more fields in a distributed database to include the generated or updated instance of the session object. As such, one or more SP servers can synchronously receive an updated or new replica of the session object and perform authorization and/or other session related operations during active sessions and/or future sessions with respect to one or more users. In addition, an instance of the distributed database at the SP servers can be synchronized with an instance of the distributed database at the IdP server. As such, the SP servers can identify and/or monitor changes to the authorization of the user and/or the validity of the session object at the IdP server and update an authorization at the SP server accordingly.

Other embodiments described herein relate generally to a distributed session management system to elicit identity consensus among servers in a federation (e.g., using a distributed database). This allows the servers in the federation to share, transmit and/or receive (e.g., via the distributed database) effectively and efficiently security events and/or risk information detected by one or more SP servers in the federation.

In other further embodiments, an SP server can receive from a client compute device a user request to access one or more resources or services provided by the SP server. Accordingly, based on a session object defined by the IdP server, the SP server can define a session object specific to that SP server (e.g., an SP token). When activating and/or allowing access to the SP server based on the session object of the SP server, the SP server can access a local distributed consensus database instance using at least one parameter included in the received user request (e.g., an identifier of the user, an identifier of the session, an identifier of the device, etc.). The SP server can determine a session status, a user related attribute, a security warning and/or one or more user access privileges based on the local distributed consensus database instance response to the session object request. Thus, the SP server can allow, partially allow, or deny access to its resources or services based on the response to the session object request. Alternatively or additionally the SP server can redirect the user request to an IdP server.

In some embodiments, a non-transitory processor-readable medium includes code to cause a processor (e.g., a processor on an identity provider server) to implement an instance of a distributed consensus database configured to be included within a set of federated or protected servers corresponding to one or more service providers. The distributed consensus database can be distributed via a network operatively coupled to the IdP server and the set of SP servers. Specifically, instances of the distributed database can be located and/or stored at the IdP server and the set of SP servers. The distributed consensus database can support multiple transactions related sessions between client compute devices and servers, user authentication and/or user authorization process executed on the set of SP servers. A distributed session management (DSM) module can be implemented in a memory or a processor of the IdP server. The DSM module can be operatively coupled with the instance of the distributed consensus database.

In some embodiments, an apparatus includes a processor of a first service provider server from a set of server provider servers and an instance of a distributed database at the first service provider server. The set of service provider servers implement the distributed database via a network operatively coupled to the set of service provider servers. The processor is configured to grant a client compute device access to a resource at a first time. The processor is further configured to identify authentication information associated with the client compute device and in the instance of the distributed database at the first service provider server at a second time after the first time in response to the authentication information being provided to an instance of the distributed database at a second service provider server from the set of service provider servers and based on a status associated with the client compute device at the second service provider server. The processor is configured to revoke access to the resource by the client compute device based on the authentication information.

In some embodiments, a method includes receiving, from a client compute device and at a server, a request to access a resource. The request can include an identifier associated with the client compute device. The method can further include accessing risk information associated with the client compute device from an instance of a distributed database at the server using the identifier. The risk information is provided to the distributed database by a set of compute devices. Each compute device from the set of compute devices implements a different instance of the distributed database. The risk information can be analyzed to identify an access decision and a level of access to the resource can be granted to the client compute device based on the access decision.

In some embodiments, an apparatus includes a processor of a first service provider server from a set of server provider servers and an instance of a distributed database at the first service provider server. The set of service provider servers implement the distributed database via a network operatively coupled to the set of service provider servers. The processor is operatively coupled to the instance of the distributed database at the first server. The processor is configured to identify an action potentially indicative of a risk posed by a client compute device. The processor is configured to store an indication of the action in the instance of the distributed database at the first server such that a second server from the set of servers can access the indication of the action from an instance of the distributed database at the second server after convergence of the distributed database and can make an authentication decision at the second server and for the client compute device based at least in part of the indication of the action.

As used herein, a module can be, for example, any assembly and/or set of operatively-coupled electrical components associated with performing a specific function, and can include, for example, a memory, a processor, electrical traces, optical connectors, software (executing in hardware) and/or the like.

As used in this specification, the singular forms “a,” “an” and “the” include plural referents unless the context clearly dictates otherwise. Thus, for example, the term “module” is intended to mean a single module or a combination of modules. For instance, a “network” is intended to mean a single network or a combination of networks.

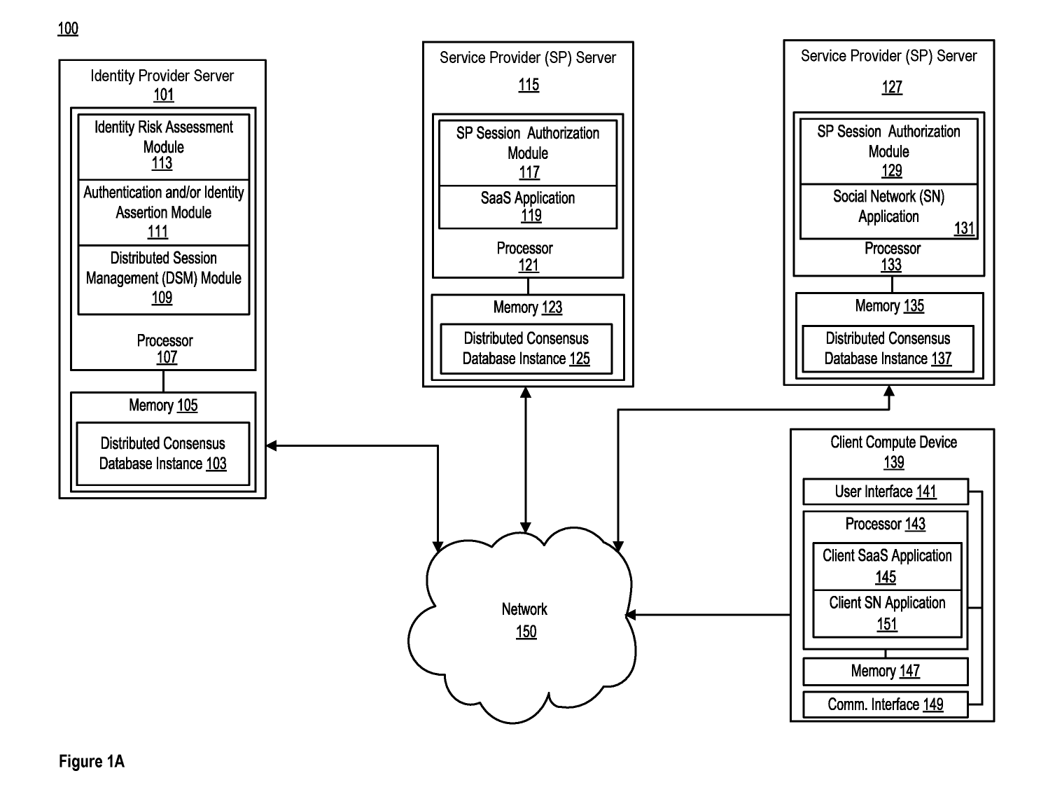

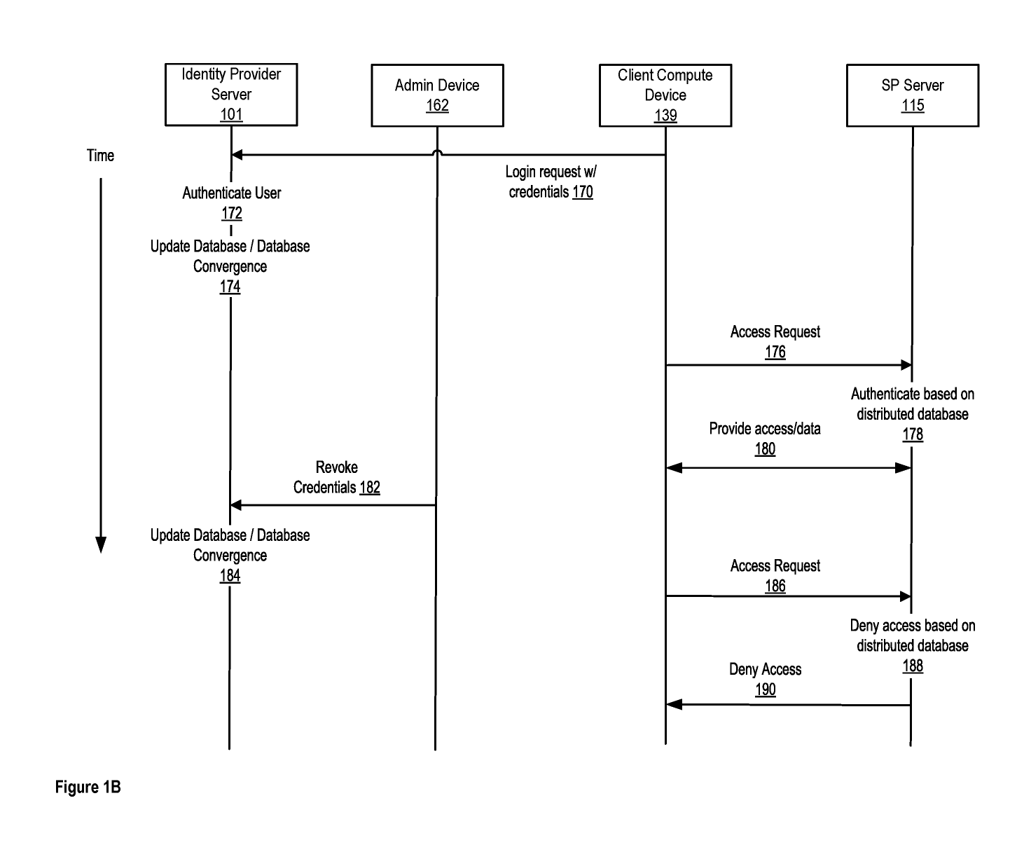

FIG. 1A is a schematic illustration of a distributed consensus system for eliciting authentication and executing identity assertion consensus among the constituent servers (e.g., in a federation). The distributed consensus system 100 includes an identity provider server 101 connected to SP servers 115 and 127 and a client compute device 139 via a network 150, according to an embodiment. FIG. 1A illustrates a distributed consensus system 100 implemented across the IdP server 101 and two SP servers (server 115, and server 127), but it should be understood that the distributed consensus system 100 can use a set of any number of servers and/or other compute devices, including servers and compute devices not shown in FIG. 1A.

As described in further detail herein, in some embodiments, the IdP server 101 and the SP servers 115, 127 are compute devices running server programs communicatively and/or operatively connected to each other via any suitable network 150 (e.g., the Internet using an Internet Service Provider (ISP)). The servers can share session data, security data, user authentication data, risk information, authentication credentials and/or any other suitable data, via distributed consensus database instances 103, 125 and 137, as described in further detail herein.

In some embodiments, a connection can be defined, via the network 150, between any two devices including the servers 101, 115, 127, and the client compute device 139. The servers 101, 115, 127 and client compute device 139 can transmit and receive data through established connections on the network 150. As shown in FIG. 1A, for example, a connection can be established between the IdP server 101 and any of the SP servers 115 and 127, and/or the client compute device 139. The servers 101, 115, 127 and the compute device 139 can communicate with each other (e.g., send data to and/or receive data from) through the network via intermediate networks and/or alternate networks (not shown in FIG. 1A). Such intermediate networks and/or alternate networks can be of a same type and/or different type of network as network 150.

Each server 101, 115, 127 and the client compute device 139 can be any type of device configured to send data over the network 150 and/or receive data from one or more servers and client compute devices. For example, each server 101, 115, 127 can be, for example, a web server, an application server, a proxy server, a telnet server, a file transfer protocol (FTP) server, a mail server, a list server, a collaboration server, a virtual server, and other similar type of servers.

In some embodiments, the client compute device 139 can be a stationary compute device (for example, desktop) or a mobile device (for example, tablet, laptop and cellular phone) and other similar compute device. In some further implementations, the client compute device 139 can be a wearable device worn by a user under, with, or on top of clothing, for example, watches, glasses, contact lenses, e-textiles, headbands, jewelry and the similar devices to communicate over the network 150. In yet some other further implementations, the client compute device 139 can be a device of the Internet of Things (IoT) transmitting telemetry data and receiving commands from other local client compute devices or remote servers including home monitoring devices, automation devices, vehicles, toys and/or similar IoT devices.

Server 115 includes SP session authorization module 117, SaaS application 119, processor 121, memory 123 and a distributed consensus database instance 125. The memory 123 can be, for example, a random access memory (RAM), a memory buffer, a hard drive, a database, an erasable programmable read-only memory (EPROM), an electrically erasable read-only memory (EEPROM), a read-only memory (ROM) a virtual memory implemented in a virtual machine and/or so forth. The memory 123 of the server 115 can include data associated with an instance of a distributed consensus database (e.g., distributed consensus database instance 125).

In some instances, the memory 123 stores instructions to cause the processor to execute modules, processes and/or functions associated with synchronizing data, sharing data, sending data to and/or receiving data from another instance of a distributed consensus database (e.g., distributed consensus database instances 103, 125 and 137). In some instances, the memory 123 stores instructions to cause the processor 121 to execute modules, processes and/or functions associated with sending to and/or receiving from another instance of a distributed database (e.g., distributed consensus database instance 103 at the IdP server 101, and distributed consensus database instance 137 at the SP server 127) a record of a synchronization event, a record of prior synchronization events with other compute devices, a session object synchronization event, a value for a parameter (e.g., a database field quantifying an authentication risk assessment or authentication strength, a database field quantifying an order in which events occur, and/or any other suitable field for which a value can be stored in a database).

In some embodiments, distributed consensus database instance 125 can be a relational database, object database, post-relational database, and/or any other suitable type of database. Distributed consensus database instance 125 can, for example, be configured to execute multiple transactions to manipulate data, including storing, modifying, and/or deleting data. Some or all the transactions to manipulate data in a local instance of a distributed database can be automatically replicated, propagated or synchronized among other instances of the database using any suitable protocol (e.g., blockchain, Paxos, Chandra-Toueg, etc.), as described in further detail herein. The distributed consensus database instance 125 can store data related to any specific function and/or industry. For example, the distributed database instance 125 can store security, authentication, authorization and session related data including a value and/or a vector of values related to security, authentication, risk, authorization, and ongoing and past sessions between the client compute device 139 and any of the servers 101, 115 and 127.

In general, a vector can be for example any set of values for a parameter, and a parameter can be for example any data object and/or database field capable of taking on different values. Thus, a distributed database instance 125 can have a number of parameters and/or fields, each of which is associated with a vector of values. The vector of values can be used to determine the actual value for the parameter and/or field within that database instance 125.

In some instances, the distributed database instance 125 can also be used to implement other data structures, such as a set of (key, value) pairs. A transaction recorded by the distributed database instance 125 can be, for example, adding, deleting, or modifying a (key, value) pair in a set of (key, value) pairs.

In some instances, the distributed consensus system 100 or any of the distributed database instances 103, 125, and 137 can be queried. For example, a query can include a key, and the returned result from the distributed database system 100 or distributed database instances 103, 125 and 137 can be a value or data structure associated with the key. In some instances, the distributed database system 100 or any of the distributed database instances 103, 125, and 137 can also be modified through a transaction. For example, a transaction to modify the database can contain a digital signature by the party authorizing the modification transaction.

In some embodiments, the distributed consensus database implemented in the distributed consensus system 100 can operate using one or more suitable distributed consensus methods. A distributed consensus method can refer to one or more techniques to define digital ledger of database transactions and share them among the servers in the distributed consensus system 100. A distributed consensus method can use cryptography to enable SP servers 115, 127 and/or an IdP server 101 to update the digital ledger in a secure way without a central authority. For example, the distributed consensus database instances 103, 125, and 137 can exchange votes to reach a consensus regarding what value should be given to a parameter or record stored in the distributed consensus database. Accordingly, a server 101, 115, 127 can propose a new value for a parameter or record stored in the distributed consensus database and other servers 101, 115, 127 in the authentication, and authorization consensus system 100 can run one or more processes to evaluate and/or verify the proposed new value. In some embodiments, whenever a majority of the servers 101, 115, 127 agree on the proposed new value, the new value can be approved and a corresponding transaction to update the parameter or record can be executed by the server 101, 115, 127 which proposed the new value. Thus, the distributed consensus database instances 103, 125 and 137 can converge to the same parameters or record values without having a dedicated server to operate as a leader. Some examples of distributed consensus methods that can be used to implement a distributed database include blockchain, Paxos, Chandra-Toueg, and/or similar techniques.

The distributed consensus system 100 can be used for many purposes, such as, for example, storing attributes associated with various users in a distributed identity system, client compute devices and/or servers. For example, such a system can use a user's identity as the “key,” and the list of attributes associated with the user as the “value.” In some instances, the identity can be a cryptographic public key with a corresponding private key known to that user. Each attribute can, for example, be digitally signed by an authority having the right to assert that attribute, for example, the IdP server 101.

Each attribute can also, for example, be encrypted with the public key associated with an individual or group of individuals that have the right to read the attribute. Some keys or values can also have attached to them a list of public keys of parties that are authorized to modify or delete the keys or values.

In another example, the distributed consensus database instance 125 can store data related to Software as a Service (SaaS) services provided by the SP server 115 (e.g., services provided by the SaaS application 119), such as the current status and ownership of ongoing session items or attributes related to services and/or resources provided via the SaaS application 119. In some instances, distributed consensus database instance 125 can be implemented within the SP server 115, as shown in FIG. 1A. In other instances, the instance of the distributed consensus database can be accessible to the SP server 115 (e.g., via a network), but is not implemented in the SP server 115 (not shown in FIG. 1A).

The processor 121 of the SP server 115 can be any suitable processing device configured to run, manage and/or implement distributed consensus database instance 125. For example, the processor 121 can be configured to update distributed consensus database instance 125 in response to receiving a signal from IdP server 101, and/or cause a signal to be sent to the IdP server 101, as described in further detail herein. More specifically, the processor 121 can be configured to execute modules, functions and/or processes to update the distributed consensus database instance 125 in response to receiving a synchronization or replication event associated with a transaction from another compute device, a record associated with an order of synchronization events, and/or the like.

In other embodiments, the processor 121 can be configured to execute modules, functions and/or processes to update the distributed consensus database instance 125 in response to receiving a value for a parameter stored in another instance of the distributed database (e.g., distributed consensus database instance 103 at memory 105 of the IdP server 101), and/or cause a value for a parameter stored in the distributed consensus database instance 125 at SP server 115 to be replicated or sent to the IdP server 101. The processor 121 can be, for example, a general purpose processor, a Field Programmable Gate Array (FPGA), an Application Specific Integrated Circuit (ASIC), a Digital Signal Processor (DSP), and/or the similar hardware implementations.

The SP session authorization module 117 can determine what type of transactions that a user operating a compute device (e.g., the client compute device 139) is allowed or not allowed to be performed. In other implementations, the SP session authorization module 117 can determine what transactions and/or type of transactions that another SP server (e.g., SP server 127) is allowed or not allowed to perform. These transactions can be made by establishing, for example, a session between a client compute device 139 and the SP server 115. A session can be a semi-permanent interactive information interchange between two communication devices. Accordingly, the SP server 115 via the SP session authorization module 117 can determine, for example, if a session request should be granted and/or if an ongoing session should be stopped, paused or interrupted. Such a determination of what transactions and/or type of transactions a user operating a compute device is authorized to perform can be based on values and/or parameters stored within the distributed consensus database instance 125. For example, the IdP server 101 can include for a user an authorization level value in the distributed consensus database instance 103. This authorization level value can be propagated, shared and/or synchronized with distributed consensus database instance 125 such that the SP session authorization module 117 can use the value in the distributed consensus database instance 125 to provide a level of access to the user (or a type of access), as described in further detail herein.

The SaaS application 119 can be a module hosted by the SP server 115 to provide one or more services and/or information to users operating a compute device over the network 150. For example, the SP server 115 can provide to the client compute device 139 an application interface via the network 150, facilitating access to one or more services and information offered by the SP server 115. In some embodiments, other types of applications can also be hosted in SP servers, for example, the social network application 131 in the SP server 127.

The SP server 127 has a processor 133, a memory 135, an SP session authorization module 129, a social network application 131, and a distributed consensus database instance 137, which can be in some aspects structurally and/or functionally similar to the processor 121, the memory 123, the SP session authorization module 117, the SaaS application 119, and the distributed consensus database instance 125, respectively. Additionally, distributed consensus database instance 137 and distributed consensus database instance 125 can be part of the same distributed consensus database.

The social network (SN) application 131 can provide an interface via which client compute device 139 can access a social network. Access to a user's account on the social network application 131 can be based on the values in the distributed consensus database instance 137. Such access can be provided similar to access to the SaaS application 119, described in detail herein. Additionally, while described as a SaaS application 119 and a social network application 131, in other instances any other suitable type of application can be accessed from a client compute device 139 and authenticated using a distributed consensus database instance such as distributed consensus database instances 125 and 137.

Identity provider server 101 can be a compute device capable of authenticating an identity of a user or a compute device (e.g., client compute device 139). Identity provider server 101 includes identity risk assessment module 113, authentication and/or identity assertion module 111, distributed session management (DSM) module 109, processor 107, memory 105, and distributed consensus database 103. In some embodiments, the authentication and/or identity assertion module 111 can receive authentication data from an SP server 115 or 127 and/or a client compute device 139. Thereafter, the authentication and/or identity assertion module 111 can verify a user identity and/or SP server identity according to the received authentication data. The authentication data can include one or more credentials (e.g., authentication credentials), user specific data, client compute device data and SP server data. Some examples of user or authentication credentials can include a user name and password. an example of user specific data can include user biometrics recorded by the client computing device 139. For example, the authentication and/or identity assertion module 111 can use biometrics derived from recorded user fingerprints and user voice patterns to measure and/or analyze unique physical or behavioral characteristics of a user. Client compute device data can include, for example, Media Access Control (MAC) addresses, Internet Protocol (IP) addresses, and/or similar data that can serve to uniquely identify a client compute device. SP server data can include one or more of publisher identifier tags, domain name, IP address, and/or similar data to uniquely identify a server.

In some implementations, the authentication and/or identity assertion module 111 can include one or more of a Kerberos protocol implementation, encrypted secret keys, public keys, server authentication processes implemented over Secure Sockets Layer (SSL), cryptographic validation by a client compute device of a server's identity, hashed password matching and similar authentication techniques. In other implementations, the authentication and/or identity assertion module 109 can use Single Sign-On services and Security Assertion Markup Language (SAML) assertion to exchange authentication data with the servers 115 and 127 and/or client compute device 139 (e.g., using the distributed database and/or tokens).

In one example, after authenticating an identity of a user of the client compute device 139, the IdP server 101 can write or insert an authentication assertion value associated with the client compute device 139 into the distributed consensus database instance 103. Such an authentication assertion value can be replicated or synchronized across other instances of the distributed consensus database, for example, distributed consensus database instance 125 and distributed consensus database instance 137. The SP servers 115 and 127 can then retrieve the authentication assertion value and based on the value can allow or deny communication sessions to a client compute device, a server and/or a user associated with the received authentication data or information.

In some implementations, in addition to adding and/or updating a value in the distributed database instance 125 associated with the user, after authenticating an identity of a user, the client compute device 139 or another server 115, 127, the IdP server 101 can generate an identity token including a user ID or personal identity number (PIN), user security/access level identifier, an indication of the specific features and resources or services provided by the application that have been approved for the user, an address of the associated application module, and/or other information that can be used by other devices within a federation (e.g., SP servers 115 and 127). In some instances, the identity token can also include, for example, an indication of the duration for which the identity token is valid, and/or other suitable information. In some instances, the identity token can be sent and stored at the client compute device 139 such that the client compute device 139 can use the identity token to access the SP server 115 and/or the SP server 127.

The identity token, for example, may or may not be generated as an empty token depending on the authentication value determined by the authentication and/or identity assertion module 111. For example, when the authentication value indicates that a user did not provide adequate authentication data to determine an irrefutable user identity, the authentication and/or identity assertion module 111 can omit the generation of an application token or can instead generate an empty identity token.

The identity token for a particular client application, for example, can be uniquely associated with a requested target resource or service from a set of approved resources or services that can be requested on the client compute device 139 of an associated with an authorized user. For example, for a specific user, identity token can provide access to service provider server 115 but not server provider server 127.

In some instances, the IdP server 101 can send an encrypted or empty identity token to the client compute device 139, a server, or another compute device. The client compute device 139 can use the identity token to provide a federated identity to one or more SP session authorization modules, for example, modules 117 and 129 in the SP servers 115 and 127 respectively.

The authentication and/or identity assertion module 111 can be operationally and/or communicatively coupled to the identity risk assessment module 113. In some instances, the authentication and/or identity assertion module 111 can receive sub-optimal or a subset of authentication data from a client compute device 139 or SP server 115, 127. Accordingly, the authentication and/or identity assertion module 111 can make a request to the identity risk assessment module 113 to provide a risk evaluation based on the received sub-optimal or subset of authentication data. The risk assessment module 113 can execute one or more probability and/or statistical methods to determine a risk assessment value associated with a client compute device (e.g., client compute device 139). The IdP server 101 can then write or insert the risk assessment value into the distributed consensus database instance 103. This risk assessment value can be replicated through an atomic transaction on other instances of the distributed consensus database, for example, distributed consensus database instance 125 and distributed consensus database instance 137. The SP servers 115 and 127 can then retrieve the risk assessment value and based on the value can allow, deny or partially deny resources and services to a client compute device, a server and/or a user associated with the received authentication data.

The identity risk assessment module 113 can periodically or frequently poll and/or monitor the records in the distributed consensus database to determine a risk assessment value. In such a case, a risk assessment value can be generated not only based on authentication or authorization requests but also from, for example, the discovery of knowledge, data patterns, and/or inference analysis of one or more records in the distributed consensus database (e.g., as gathered and/or calculated by the SP servers 115, 127 and/or other third-party devices). A risk assessment value associated with a user identity or client compute device can be determined from historical data and/or tracked user behavioral data collected by one or more constituents of the distributed consensus system or other third-party compute devices. For example, the distributed consensus database can be periodically, sporadically, and/or substantially continuously updated to include indications of risk based on interactions between one or more SP servers and that user and/or client compute device, a risk assessment calculated and/or determined by a third-party risk assessment service (not shown in FIG. 1), and/or based on information about the user and/or client compute device identified and/or calculated by any other device. Such indications of risk can be used by the identity assessment module 113 to periodically, sporadically, and/or substantially continuously update a risk assessment value associated with the user and/or client compute device.

In addition to being used by the identity risk assessment module 113 at the identity server 101, the risk assessment value can also be used by other entities (e.g., SP servers 115 and 127) having distributed consensus database instances to determine a risk of allowing access to the user and/or client compute device 139. For example, if the risk assessment value associated with client compute device 139 (e.g., calculated based on interactions of the client compute device 139 with the SaaS application 119 and the identity provider server 101 stored in the distributed consensus database) does not meet a criterion associated with SP server 127, SP server 127 may determine to deny the client compute device 139 access to the SN application 131.

The distributed session management (DSM) module 109 can implement a collection of multiple logically interrelated database tables distributed locally and over the SP servers 115, 127 and other servers. Accordingly, a distributed consensus database instance 103 can be implemented in the memory 105 of the IdP server 101. The distributed consensus database instance 103 can be structurally and/or functionally similar to distributed database consensus instance 125 and 137 respectively implemented by the SP server 115 and the SP server 127. Specifically, distributed consensus database instance 103, distributed consensus database instance 137 and distributed consensus database instance 125 can be part of the same distributed database.

The IdP server 101 has a processor 107, and a memory 105, which can be in some aspects structurally and/or functionally similar to the processor 121, and the memory 123 in the SP server 115. Also, the IdP server 101 has a distributed consensus database instance 103, which can be structurally and/or functionally similar to distributed database consensus instance 125. The servers 101, 115 and 127 can execute read and write operations over the data stored in the instances of the distributed consensus database ensuring the Atomicity, Consistency, Isolation and Durability (ACID) of the stored data.

The client compute device 139 can be any suitable client compute device, as described above. Specifically, client compute device 139 includes a processor 143 coupled to a memory 147 with a set of executable instructions to exchange data, for example, user credentials, user data, and client compute device data with the servers 101, 115, and 127. The transmission and reception of data between the client compute device 139 and the servers 101, 115, 127 can be performed through the communication interface 149 across the network 150. The client compute device 139 can load and execute a client SaaS application 145 hosted by an SP server, for example, the SP server 115. Additionally or alternatively, the client compute device 139 can load and execute a client social network application 151 hosted by an SP server, for example the SP server 127. A user can exchange data related to services and resources facilitated through the client SaaS application 145 via the user interface 141.

While described herein as a distributed consensus database, in other implementations any other suitable type of structured data held in memory and distributed across devices (e.g., SP servers 115, 127 and IdP server 101) can be used. For example, in some implementations, the block elements 103, 125 and 137 can be implemented as instances of a consensus directory, instances of a written file, instances of a memory object and/or any other suitable memory structure. An instance of a consensus directory, for example, can store a set of records distributed or replicated over the memories 105, 123 and 135 (as described herein with respect to a distributed consensus database). In such instances, each of the instances of the consensus directory can be synchronized and/or can converge similar to the distributed consensus database described herein, such that, they contain the same set of records or a subset or records.

FIG. 1B is a message flow diagram of an example operation of the distributed consensus system 100, according to an embodiment. For example, the client compute device 139 can provide a login request including credentials to the IdP 101, at 170. The IdP 101 can then authenticate the user and/or the client compute device 139 based on the credentials, at 172. For example, the authentication and/or identity assertion module 111 of the IdP 101 can use the credentials to authenticate the user and/or the client compute device 139.

Based on the authentication (at 172), the IdP 101 can update the database (e.g., the distributed consensus database instance 103 at the IdP 101) to include an indication that the user and/or the client compute device 139 has been authenticated by the IdP 101, at 174. The distributed consensus database instances of the distributed database can then converge, at 174, such that the indication that the client compute device 139 has been authenticated by the IdP 101 is replicated across each instance of the distributed consensus database.

In some instances, the IdP 101 can also generate and provide an identity token to the client compute device 139 in response to the IdP 101 authenticating the user and/or the client compute device 139. The client compute device 139 can store this identity token and subsequently use this identity token to access SP servers (e.g., SP server 115), as discussed herein. In still other instances, the IdP 101 can instead generate and provide an identity reference (e.g., a pointer, an alphanumeric character string, etc.) instead of an identity token to the client compute device 139. Such an identity reference can, for example, correspond to a record and/or artifact stored in the distributed consensus database. The identity reference can be embodied in any suitable data structure (e.g., a certificate, a cookie, an encrypted value, etc.) and can be stored at the client compute device 139. In this manner, a larger portion of the identity information (e.g., an identity artifact) generally provided in the identity token can be instead stored within the distributed consensus database and referenced by the identity reference.

The client compute device 139 can then send an access request to the SP server 115, at 176. This access request can be a request to access data and/or services at the SP server 115. For example, the access request can be a request to access the SaaS application 119 at the SP server 115.

Based on the access request, the SP server 115 can authenticate the client compute device 139 and/or the user based on the indication in the distributed database that the user and/or the client compute device 139 has been authenticated by the IdP 101. Specifically, the SP session authorization module 117 (shown in FIG. 1A) can access the distributed consensus database instance 125 (shown in FIG. 1A) to verify that the distributed database includes an indication that the user and/or the client compute device 139 has been authenticated by the IdP 101. Based on this indication, the SP server 115 can authorize the user and/or the client compute device 139 to access the SP server 115 (and/or specific application at the SP server 115), at 180.

In some instances, the access request at 176 can also include the identity token. In such instances, the SP server 115 can use the identity token in addition to the distributed database to authenticate the user to the SP server 115. Moreover, in some instances, the SP server 115 can generate an application token based on authorizing the user and/or the client compute device 139 at the SP server 115. This application token can be provided to and stored at the client compute device 139. Moreover, in some instances, this application token can be provided by the client compute device 139 to the SP server 115 when the client compute device 139 subsequently requests access to the SP server 115.

In instances in which the IdP 101 generates and provides an identity reference instead of an identity token, the access request at 176 can include the identity reference. In such instances, the SP server 115 can use the identity reference to search for and retrieve the corresponding information (e.g., an identity artifact) from the distributed consensus database. This information can then be used to authorize access of the client compute device 139 to the SP server 115. Moreover, in some instances, the SP server 115 can generate an application reference (instead of an application token) based on authorizing the user and/or the client compute device 139 at the SP server 115. This application reference can be provided to and stored at the client compute device 139. Moreover, in some instances, this application reference can be provided by the client compute device 139 to the SP server 115 when the client compute device 139 subsequently requests access to the SP server 115. Accordingly, similar to the identity reference, the application reference can be used to access information (e.g., an application artifact associated with the SP server 115) within the distributed consensus database when provided to the SP server 115 in subsequent access requests.

At a later point in time, a user and/or network administrator, via an administration device 162 (which can be a compute device operatively coupled to network 150 in FIG. 1A), can send an instruction and/or a signal to the identity provider server 101 to revoke the credentials of the user and/or the client compute device 139, at 182. Such an instruction and/or signal can be, for example, in response to the employment of the user terminating, malicious activity of the user being detected, a change of access and/or role of the user, and/or the like. In other instances, any other device and/or individual can initiate and/or send the instruction and/or signal to revoke the credentials of the user and/or the client compute device 139. In some instances, for example, an application can send the instruction and/or signal based on a timeout value for the credentials.

Based on the instruction and/or signal, the IdP server 101 can update the distributed consensus database to indicate that the user and/or the client compute device 139 is no longer authorized by the IdP server 101 by updating its distributed consensus database instance 103, at 184. This indication and/or update can then be propagated to the other instances of the distributed consensus database as the instances converge.

After the distributed database has been updated, at 184, the client compute device 139 can send another access request at 186 to the SP server 115. The SP server 115 can query the distributed consensus database (specifically the SP authorization module 117 can query the distributed consensus database instance 125) and can determine that the user and/or the client compute device 139 is no longer authorized by the IdP 101, at 188. The SP server 115 can then deny access to the SP server 115 by the client compute device 139, at 190. Thus, the distributed consensus database can be used to exchange identity and access information between multiple devices.

In some instances, the access request, at 186, can include the application token generated by the SP server 115. In such an instance, the application token may still be a valid application token. Although the client compute device 139 provides a valid application token, the SP server 115 can still deny access to the SP server by the client compute device 139 based on the distributed consensus database. Thus, in some instances, the SP server 115 provides access only when both a token (e.g., an authentication token such as an identity token or an application token) is valid and the distributed consensus database indicates that the user and/or the client compute device 139 is authenticated. In other instances, the SP server 115 can provide access solely based on the indications in the distributed consensus database. In still other instances, the SP server 115 can receive the application reference, and after retrieving the corresponding record and/or artifact in the distributed consensus database based on the application reference, can determine that access should be denied.

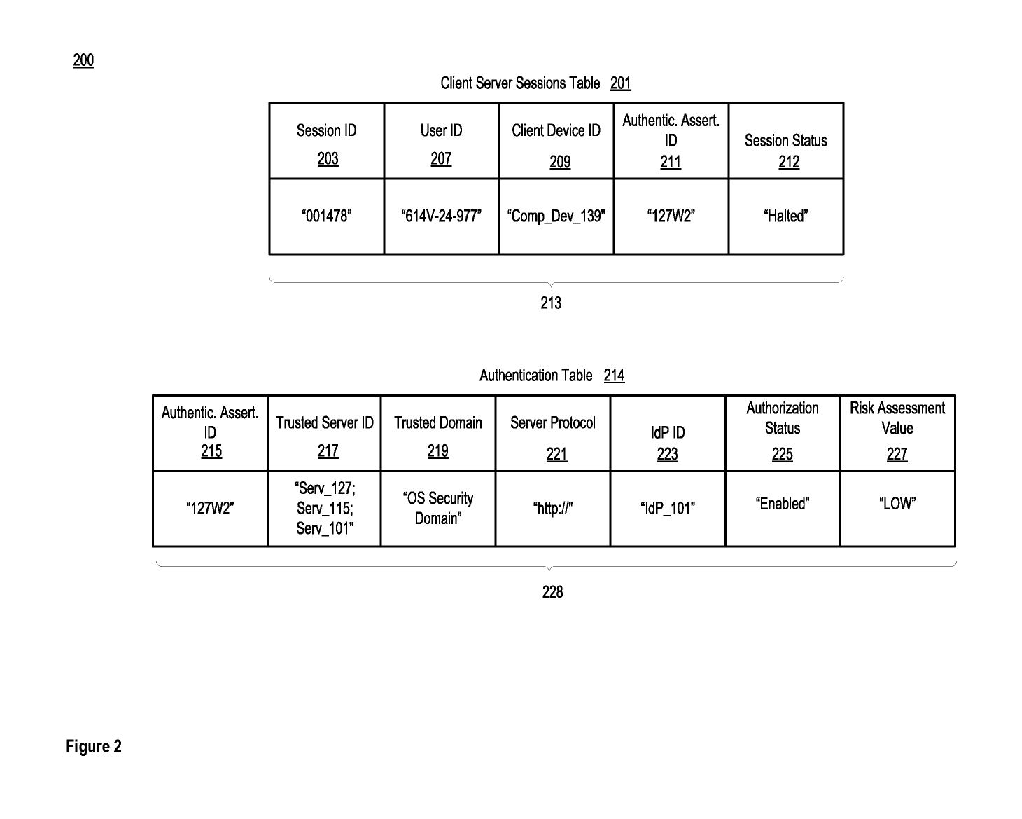

FIG. 2 is an example of the tables and fields included in a distributed consensus database 200, according to an embodiment. Distributed consensus database 200 can, for example, store data and data structures representing numerous entities including session related data, user identifiers, server identifiers, client compute devices identifiers, and their interrelationships. In some embodiments a distributed consensus database 200 can be a relational database structured to specify relations among stored information items. In some embodiments, distributed consensus database 200 can be similar to distributed database instances 103, 125 and 137, shown and described with respect to FIG. 1A. As such, the state and/or values of the tables in the distributed consensus database 200 can be updated and/or determined based on a distributed consensus process as described above such that the instances of the distributed consensus database can converge to a common value based on communication and data exchange between the different instances of the distributed consensus database.

The distributed consensus database 200 can include a client server session table 201. The client server session table 201 can include numerous fields related to the client server sessions; for example Session ID 203, User ID 207, Client Device ID 209 and Authentication Assertion ID 211 can store unique identifiers of other data structures representing sessions, users, client compute devices, and authentication assertions objects respectively. Other fields included in the client server session table 201 may not represent unique identifiers of other data structures; for example, Session Status 212 can store values related to an operational condition of a client server session, including values such as halted, ongoing, negated, warning, and similar types of federated session's status values.

Some of the fields in the client server session table 201 can be foreign keys of other tables within the distributed consensus database 200. For example, the Authentication Assertion ID 211 can be a foreign key in the client server session table 201 and a primary key in the authentication table 214.

The authentication table 214 can include fields describing further attributes of an authentication assertion. The Authentication Assertion ID 215 can store a unique identifier to identify an authentication object, for example, an SSO object. The Trusted Server ID field 217 can store data structures or list identified trusted and/or protected servers in a federation. The Trusted Domain field 219 can store data structures or lists of trusted domain names of the servers in the federation. The Server Protocol field 221 can store an identifier of a communication protocol used by an authentication or identity assertion module (e.g., module 111 in the IdP server 101). The IdP ID field 223 can store an identifier (e.g., domain name and/or IP address) of an authentication server (e.g., IdP server 101). The Authorization Status field 225 can store a value indicating if an entity has an enabled or disabled authorization to communicate with one or more compute devices or servers in a federation, the authorization status can be, for example, established and updated by a server in the federation and/or the IdP server 101 in the distributed consensus system 100 shown in FIG. 1A. The Risk Assessment Value field 227 can store the result of a risk assessment provided by, for example, the risk assessment outcome that can be determined and/or calculated by the Identity Risk Assessment Module 113 of the IdP server 101.

In other instances, the tables in the distributed consensus database can store other values and/or parameters related to the authentication status of a user and/or client compute device. For example, the distributed consensus database can store an expiration date and/or time for identity and/or application tokens, an expiration date and/or time for an authentication, a date and/or time at which a user will need to reauthenticate, and/or the like. The expiration dates, time for identity or other similar types of timestamps can be associated with one or more records of the distributed consensus database 200. As such, a server or other third-party compute device implementing a distributed consensus database instance can remove one or more records from its instance of the distributed consensus database or can consider these records no longer valid to achieve one or more transactions after the expiration date and/or time.

In some instances, timestamps in the distributed consensus database can be used to ensure the distributed consensus database does contain old and/or outdated records. For example, a distributed consensus database can include records and/or files associated with one or more timestamps indicating when a record can be deleted and/or removed from the distributed consensus database. In some instances, this can be accomplished by comparing a time stamp of a recently received and/or added record with the time stamps of the other records in the distributed consensus database. If the time between the time stamps is greater than a threshold, the older records can be deleted and/or removed from the distributed consensus database. In such instances, each distributed database instance can independently perform this comparison and can independently remove and/or delete such older records. In other instances, a delete date and/or time can be stored with the record in the database. That record can then be removed from the database as of that date and/or time.

Other tables not shown in FIG. 2 can include for example server to server sessions or sessions occurring among similar types of compute devices, user tables with user related information, including user credentials and user biometrics and user behavioral metrics, client computing device tables, service provider servers and the like entities of a distributed consensus system.

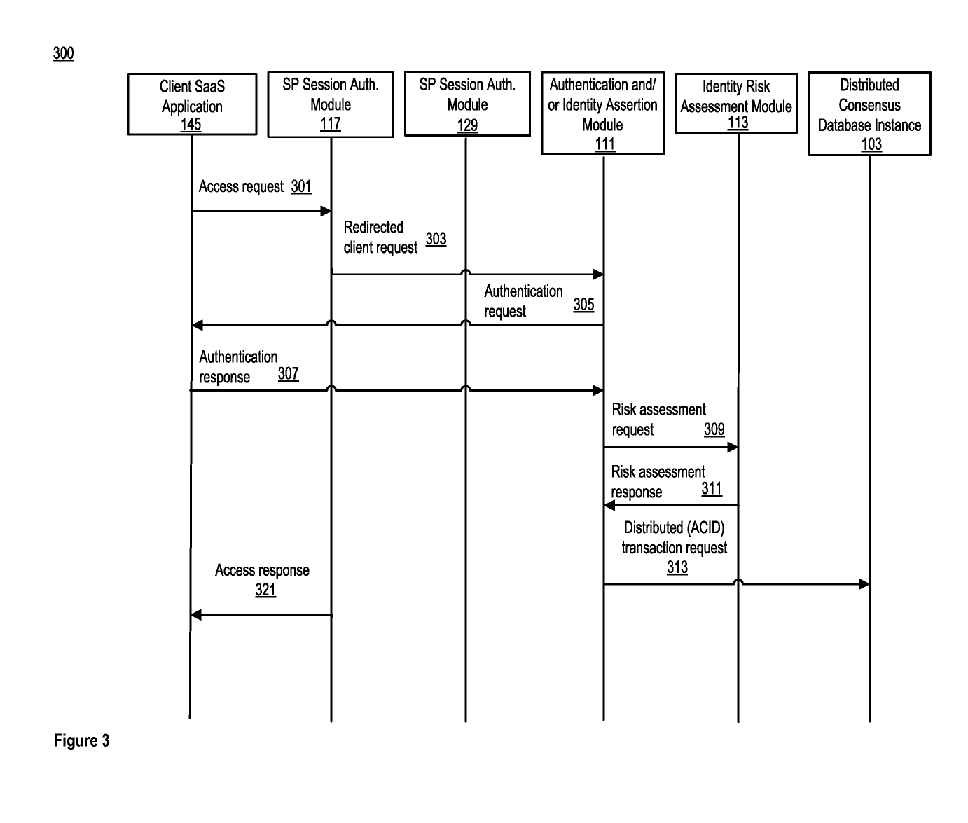

FIG. 3 is a message flow diagram illustrating a method 300 of determining an access response to an SP server and synchronizing user session attributes among the constituents of a distributed consensus system according to an embodiment. FIG. 3 is discussed in reference to the authentication and authorization of client compute device running a client SaaS application 145 in the distributed consensus system 100, shown and described with respect to FIG. 1A.

As shown in FIG. 3, a user operating a client compute device (e.g., client compute device 139 in FIG. 1A) running the client SaaS application 145 can request access, at 301, to a protected SP resource or service hosted by a SP server (e.g., SP server 115 in FIG. 1A). The request can be received by the SP session authorization module 117 of the SP server. In some instances, when the user requesting access is not already authenticated and/or logged on to the SaaS application or site hosted by the SP server, the SP session authorization module 117 can generate an authentication request and redirect, at 303, the client request to an authentication and/or identity assertion module 111 implemented in the IdP server 101 also shown in FIG. 1A. For example, the SP session authorization module 117 can access a record associated with the user and/or user device in an instance of the distributed database at the SP server. If the instance of the distributed database at the SP server indicates that the user is not currently authenticated with the IdP server 101, the SP session authorization module 117 can send a request to the IdP server 101 to authenticate the user.

In some instances, when the user is not already authenticated and/or logged on to the IdP server 101 or if re-authentication is required (e.g., authentication with the IdP server 101 has expired), the authentication and/or identity assertion module 111 can send an authentication request, at 305, to the client SaaS application 145 (or any other application associated with the IdP server 101 on the client compute device 139). The authentication request, at 305, can prompt the user of the client SaaS application 145 to enter user authentication data including one or more user credentials, user specific data, and/or client compute device data. The client SaaS application 145 can send an authentication response 307 including one or more of the authentication data requested through the authentication request 305.

In some instances, the authentication and/or identity assertion module 111 can act as an authorization server (e.g., an OAuth Authorization Server), facilitating the authentication of a user identity requesting resources or services through the client SaaS application 145. In some instances, the authentication and/or identity assertion module 111 can issue an identity token to the client compute device 139 that can be used by a user to access subsequent resources or services provided by other SP servers in the distributed consensus system including the SP server implementing the SP session authorization module 117.

In some instances, the authentication and/or identity assertion module 111 can send a risk assessment request, at 309, to an identity risk assessment module 113. The risk assessment module 113 can be implemented in the IdP server 101 shown in FIG. 1A or other server (e.g., within an SP server) in the distributed consensus system. The risk assessment request, at 309, can include one or more of the authentication data received in the authentication response, at 307. Accordingly, the identity risk assessment module 113 can execute one or more probability and/or statistical methods to determine a risk assessment value, a risk score or authentication strength associated with the authentication data received in the authentication response 307. Some of the factors that can be analyzed by the identity risk assessment module 113 can include, for example, a user's usage profile, the client compute device running the client SaaS application 145, the geographic location of the client compute device running the client SaaS application 145, the resources and/or services the user is trying to access, the time of day a user typically request access to one or more SP servers, IP addresses of the client compute device attempting to established a session, session history between a client compute device and an SP server (e.g., whether the client compute device has been found to be malicious in the past) and similar type of user specific data, user behavioral data, client-server specific data and/or client compute device specific data. The identity risk assessment module 113 can combine the received values to determine and/or calculate the risk assessment value. Thereafter, the identity risk assessment module 113 can send a risk assessment response, at 311, to the authentication and/or identity assertion module 111 with a risk assessment value, risk score or authentication strength expressed in a qualitative or quantitative form, for example some qualitative values can be low risk, medium risk, high risk and the like ordinal values.

As described above, in some instances, the identity risk assessment module 113 can periodically or frequently poll and/or monitor the records in the distributed consensus database to determine a risk assessment value. Thus, the risk assessment value can be periodically and/or sporadically updated based on interactions between one or more SP servers and that user and/or client compute device, a risk assessment calculated and/or determined by a third-party risk assessment service, and/or based on information about the user and/or client compute device identified and/or calculated by any other device.

In other instances, each SP server and/or IdP server can implement its own risk assessment module. In such an instance, each SP server and/or IdP server can obtain risk information from the distributed consensus database (e.g., as stored in the distributed consensus database by the SP servers and/or IdP servers within the network) and use the risk information to determine a risk assessment value specific to that SP server and/or IdP server. Similarly stated, the underlying risk information can be shared via the distributed consensus database and each server can use this information to calculate a risk assessment value for that SP server and/or IdP server.

In some instances, the authentication and/or identity assertion module 111 can execute a distributed ACID transaction request, at 313, to the distributed consensus database instance 103. Such a request can include, for example, one or more database transactions or operations including inserting a record in one or more tables, updating a record in one or more tables, and/or merging records from one or more tables in the distributed consensus database instance 103. Specifically, the authentication and/or identity assertion module 111 can, at 313, store in the distributed consensus database instance 103 a value indicating that the user and/or device is authenticated. Additionally, in some instances, the authentication and/or identity assertion module 111 can store in the distributed consensus database instance 103 the risk assessment value. Thereafter, other instances of the distributed consensus database, for example instance 125 and instance 137 in the SP server 115 and 127 shown in FIG. 1A can be synchronized and/or can converge to reflect the latest changes made to the distributed consensus database instance 103. The records in the distributed consensus database instance can be the same or similar to the records described with respect to FIG. 2.

The SP server 115 can query the distributed consensus database (specifically the SP authorization module 117 can query the distributed consensus database instance 125) and can determine an access level for the user operating the client compute device 139 based on the risk assessment value, risk score or authentication strength stored in the distributed consensus database. For example, the SP session authorization module 117 can compare the risk assessment value against one or more thresholds to determine an access level to the user operating the client compute device 139. The authentication and/or authorization module 111 can then send an access response to the client SaaS application 145 indicating whether to allow, partially allow or deny access to the resources hosted by a server, for example, the SP server 117 shown in FIG. 1A.

For example, the SP session authorization module 117 can include various thresholds and/or criteria for different levels of access to the SP server 115 and/or the client SaaS application 145. For example, when a risk value stored in the distributed consensus database indicates little to no risk for that user and/or client compute device 139, the user and/or client compute device 139 can meet the criterion for full access (e.g., read and write access) to the SP server 117. For another example, when a risk value stored in the distributed consensus database for that user and/or client compute device 139 indicates a high risk, the SP server 117 can deny access even though that user and/or client compute device 139 is authenticated to some degree. For yet another example, when a risk value stored in the distributed consensus database indicates a medium risk level (i.e., the risk value does not meet the criterion for full access but does not indicate a high risk), the user and/or client compute device 139 can meet the criterion for partial access (e.g., read access but not write access) to the SP server 117. The SP server 117 can grant access accordingly.

Moreover, different SP servers can set different thresholds for different levels of access to those SP servers. Thus, SP servers can use and/or grant access using the risk value stored in the distributed consensus database in varying manners. For example, a first SP server may grant full access for a certain access level and/or risk value stored in the distributed consensus database, but a second SP server may grant only partial access based on the same risk value.

In other embodiments, the SP authorization module 117 can implement one or more database transaction listeners (e.g., an application and/or process executed by a processor at one or more of the servers 101, 115, 127 hosting instances of the distributed consensus database) operating over the distributed consensus database instances 103, 125, 137 shown in FIG. 1. Thus, in such embodiments the SP authorization module 117 can include an implemented listener that triggers and executes a notification process whenever a transaction is made to an instance of the distributed consensus database. The listener can identify changes irrespective of whether the changes were originated at a local distributed consensus database instance or a remote instance. For example, a listener operating over the distributed consensus database instance 125 in the SP server 115 shown in FIG. 1A can notify the SP session authorization module 117 (also implemented by the SP server 115) of a change made to the distributed consensus database 103 as a result of a distributed transaction ACID request.

In other embodiments, the authentication and/or identity assertion module 111 can send commands and/or notifications directly to one or more SP session authorization modules. For example, when an authorization and/or identity assertion module 111 determines that the authentication data provided by a user in the authentication response 307 is false or inaccurate, the authentication and/or identity assertion module 111 can send a message to one or more SP session authorization modules. Thus, the authentication and/or identity assertion module 111 can send, for example, a failed authentication to third-party SP message, to an SP session authorization module. For example, the SP server implementing the SP session authorization module 129 (i.e., SP server 127 in FIG. 1) can have an ongoing session, with a client compute device (e.g., client compute device 139 in FIG. 1) through the client social network application 151. The SP session authorization module 129 can send instructions to the client social network application 151 to execute a command to handle a third-party authentication failure event. Some examples of commands for handling a third-party authentication failure event include pausing an ongoing session, terminating an ongoing session, and/or sending a re-authentication prompt to a user to keep the ongoing session alive. In this manner, the devices within the distributed consensus system 100 can send notifications for urgent authentication and/or risk matters (e.g., such that a user has been denied access).

In some instances, the authentication and/or identity assertion module 111 can send a failed authentication message to an SP session authorization module. For example, the failed authentication message can be sent when the authorization and/or identity assertion module 111 determines that the authentication data provided by a user in an authentication response is false or inaccurate.

In some embodiments, the data in the failed authentication to third party SP message, and/or the failed authentication message, can be included in a distributed ACID transaction request and stored in the distributed database. Likewise, other type of data generated by the authentication and/or identity assertion module 111, the identity risk assessment module 113 and the SP session authorization modules 117 and 129 can be stored in the distributed consensus database instance. As discussed above, the IdP server 101 and each of the SP servers 115 and 127 can exchange messages and indications of transactions or operations made to the distributed consensus database instances 103, 125 and 137, such that the distributed database instances can converge.

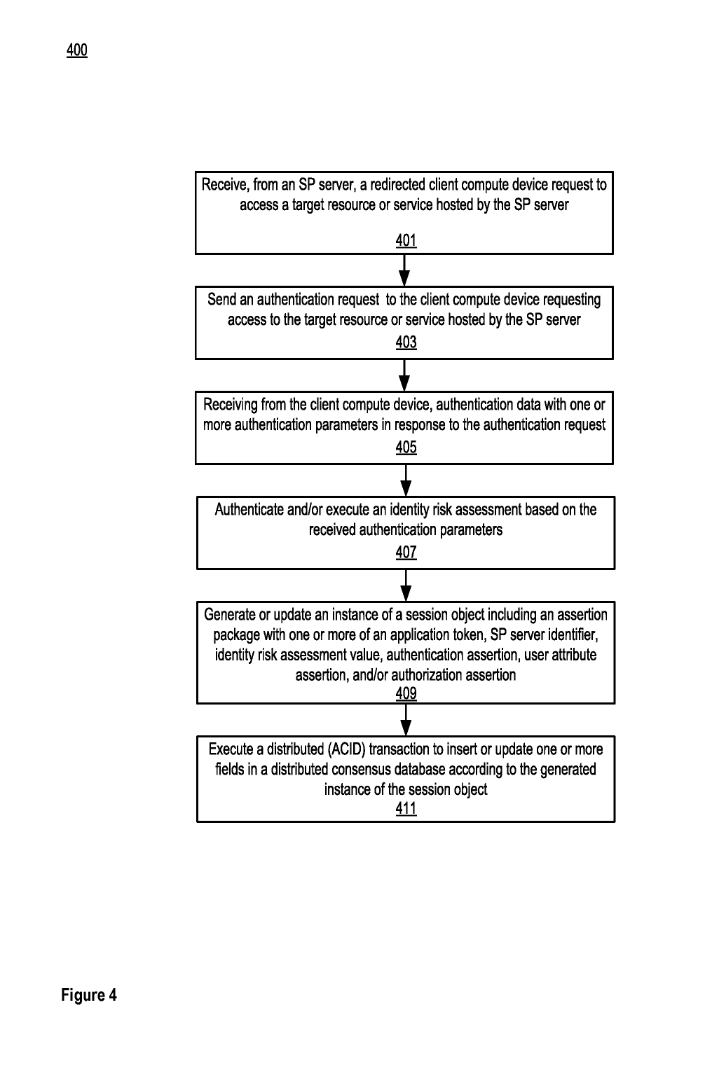

FIG. 4 is a flow chart illustrating a method of generating a session object associated with a user identity and synchronizing user session attributes among the constituents of a distributed consensus system, according to an embodiment. The method 400 can be executed on an IdP server, for example, the IdP server 101 shown in FIG. 1A. The method 400 includes receiving, from an SP server, a redirected client compute device request to access a target resource or service hosted by the SP server, at 401. As discussed above, the SP server can provide, for example, SaaS application services, social network services, electronic publication services and the like type of services.

In response to the redirected client compute device request, an authentication request can be sent to the client compute device requesting access to the target resource or service hosted by the SP, at 403. The authentication request can prompt a user to enter or submit authentication data for example, via a login webpage or other similar user interfaces.

At 405, the requested authentication data can be received including one or more authentication parameters. As discussed above, the authentication data can include one or more credentials, user specific data, client compute device data and/or SP server data. Thereafter an authentication process can be executed based on the received authentication data and alternatively or additionally an identity risk assessment can be performed, at 407. A risk assessment value can represent an authentication strength that can be inferred or calculated based on the received authentication data. In other instances, any other suitable data can be used to determine the risk assessment value such as, for example, a user's usage profile, the client compute device running the client SaaS application, the geographic location of the client compute device running the client SaaS application, the resources and/or services the user is trying to access, the time of day a user typically request access to one or more SP servers, IP addresses of the client compute device attempting to established a session, session history between a client compute device and an SP server (e.g., whether the client compute device has been found to be malicious in the past) and similar type of user specific data, user behavioral data, client-server specific data and/or client compute device specific data. Such data can be retrieved from the instance of the distributed consensus database at the IdP server. In such instances, such data can be identified by and/or stored in the distributed consensus database by any SP server and/or IdP server having an instance of the distributed consensus database.

An instance of a session object including an assertion package with one or more of an application token, an SP server identifier, an identity risk value, an authentication assertion, a user attribute assertion and/or authorization assertion can be generated at 409. For example, in some embodiments a session object can include a SAML type of assertion package with an authentication assertion indicating whether or not a user or other entity was successfully authenticated by an IdP server, a user attribute assertion indicating whether or not a user has one or more specific attributes including user role, user name, user email and the like user specific attributes, and a user authorization assertion including a value indicating if a request to allow a user to access a resource or service has been granted or denied.

At 411, a distributed ACID transaction to insert or update one or more fields in a distributed consensus database according to the generated instance of the session object can be executed. As discussed with respect to FIG. 2 the distributed consensus database can include one or more tables with fields specifying relational data of, for example, authentication processes; client server sessions; server to server sessions; user related information or attributes, including user credentials and user metrics; data related to client computing devices; data related to service provider servers; and/or the like data related to entities in the distributed consensus system. Thereafter, one or more servers in the distributed consensus system shown in FIG. 1A can have access to new and/or updated data via their local distributed consensus database instances (e.g., instance 125 locally implemented by the SP server 115 and instance 137 locally implemented by the SP server 127 shown in FIG. 1A).

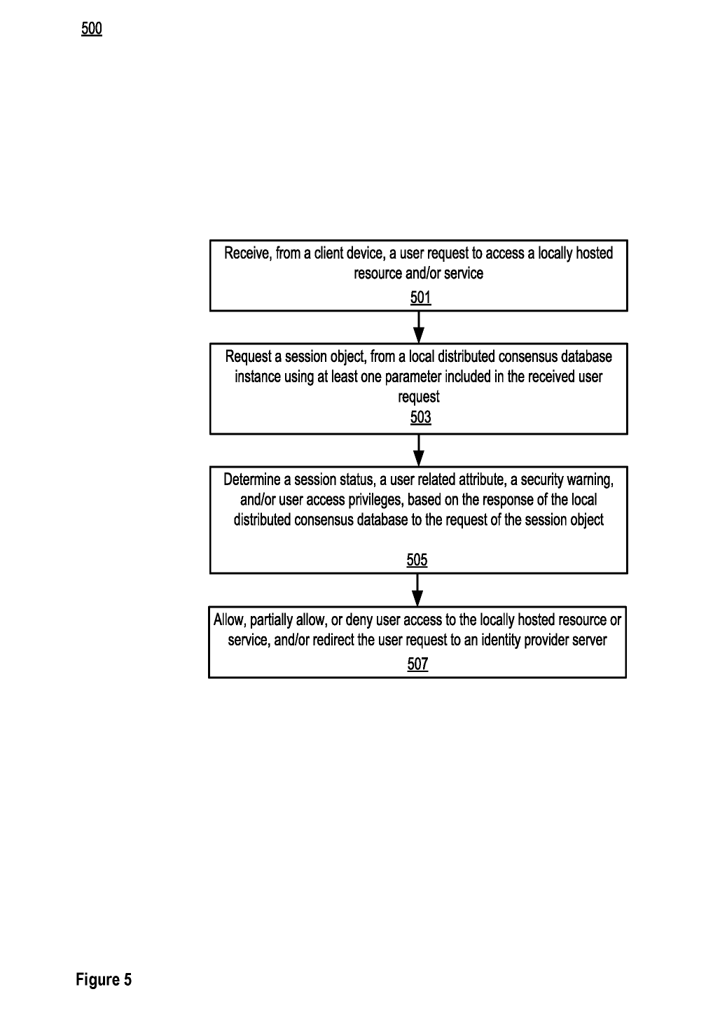

FIG. 5 is a flow chart illustrating a method of validating a session request from a client compute device to an SP server through a session object locally stored in the SP server, according to an embodiment. The method 500 can be executed on an SP server, for example, the SP server 115 or the SP server 127 shown in FIG. 1A. The method 500 includes receiving, from a client compute device, a user request to access a locally hosted resource and/or service at 501. For example, a locally hosted resource or service associated with the SaaS application 119 implemented by the SP server 115 in FIG. 1A. For another example, a locally hosted resource or service can be provided by a social network application 131 implemented by the SP server 127 also shown in FIG. 1A.

At 503, a value of an authentication parameter can be retrieved from a local distributed consensus database instance using at least one parameter included in the received user request. In some implementations, the parameter can be associated with, for example, an ongoing session identifier, a user identifier, a client compute device identifier and/or similar type of data that can be used to query and/or retrieve a value of the authentication parameter from a distributed consensus database instance. Thereafter, one or more values can be determined based on the response of the local distributed consensus database to the request of the value of the authentication parameter, at 505. The one or more values can include, for example, a session status, a user related attribute, a security warning, user access privileges and similar type of data related to a user, client compute device and/or session. Accordingly, in some embodiments, at 507 a user access request to the locally hosted resource or service requested in 501 can be allowed, partially allowed or denied. In other embodiments, at 507, the user request can be redirected to an identity provider server, for example, the IdP server 101 in FIG. 1A to further authenticate the user before providing any access to the locally hosted resources and/or services.

While described above with respect to devices in a federation and/or single sign on (SSO) group of devices, in other instances information can be exchanged between devices not within a federation. For example, any device having an instance of the distributed database can exchange information. Such information can be used for authentication and/or other purposes, such as, for example, risk assessment, user preference information exchange, data exchange, and/or the like.

While shown and described above as having an IdP server to authenticate a user and/or device, in other embodiments, an IdP server is not used. In such instances, SP servers can exchange authentication information with other SP servers using a distributed consensus database. Based on an extent to which a specific SP server to which the user is requesting access trusts the other SP servers, that SP server can grant access to the user and/or the client compute device associated with that user. For example, if a majority of SP servers have already indicated that they have authenticated the user and/or client compute device associated with the user, the specific SP server may decide to grant access to the user and/or the client compute device associated with the user without requesting additional authentication information.

For another example, in some instances the distributed consensus database can include an indication of requirements for authentication with specific SP servers. In such instances, if the SP server to which the user is requesting access determines, using the distributed consensus database, the that an SP server (or a number of SP servers above a threshold) having similar authentication requirements has previously authenticated the user and/or client compute device, the SP server can provide access to the user and/or client compute device without requesting additional authentication information.

While described above as exchanging information related to authentication and/or authorization of a user and/or client compute device, in other instances any other suitable information can be exchanged using the distributed consensus database. For example, the devices can exchange information associated with a risk associated with specific devices. If, for example, a specific server identifies malicious behavior associated with a client compute device (e.g., as indicated by an IP address), that server can add an entry into the distributed consensus database associated with this risk. Other devices can then review this risk and act accordingly. For another example, devices can exchange any other suitable information, such as, for example, transaction information, preference information associated with specific users and/or devices, and/or the like.

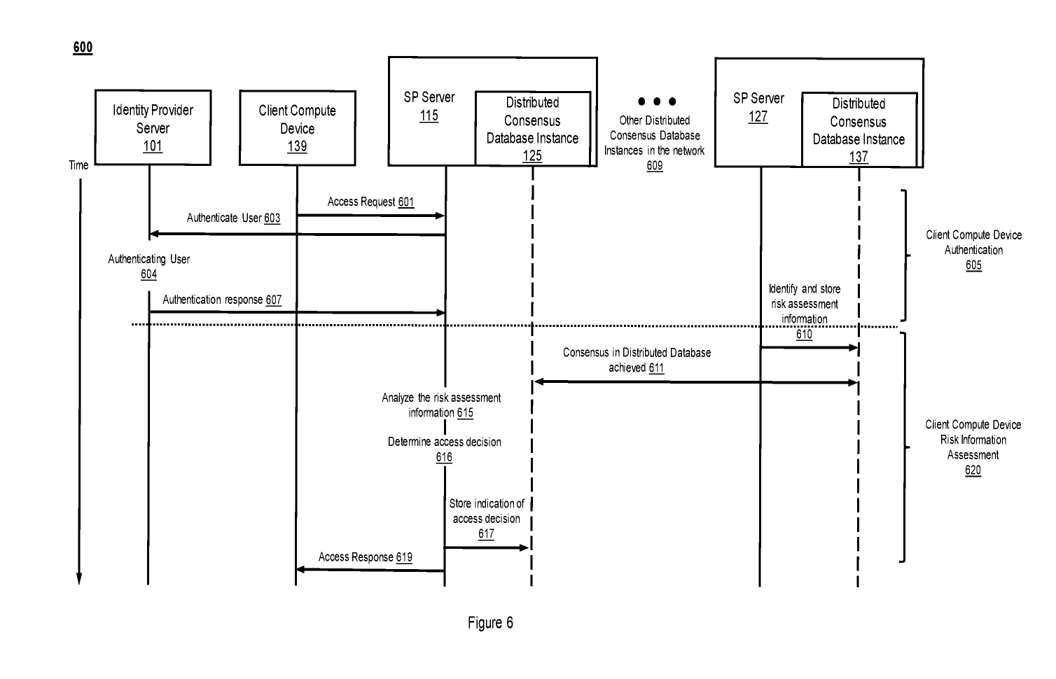

FIG. 6 is a message flow diagram illustrating a method 600 of determining an access response at an SP server based on risk assessment information from a distributed consensus databases, according to an embodiment. The method 600 includes a client compute device authentication process 605 and a client compute device risk information assessment 620.

In the client compute device authentication process 605, the client compute device 139 sends an access request to the SP server 115, at 601, for accessing the services offered by SP server 115. The access request made by the client compute device 139 can be a request to access at least some data, locally-hosted resources and/or services at the SP server 115. In some instances, the SP server 115 can provide, for example, SaaS application services, social network services, electronic publication services and/or other suitable types of services. For example, the access request can be a request to access the SaaS application 119 (shown in FIG. 1A) at the SP server 115.

After receiving the access request from the client compute device 139, the SP server 115 sends a request to the IdP server 101 to authenticate client compute device 139 (or user), at 603. The request sent by the SP server 115 to IdP server 101 can include the authentication information (such as login credentials, other user-related information and/or other similar authenticating parameters). The request to authenticate a user, at 603, is serviced by the IdP server 101, at 604. Specifically, the IdP server 101 can authenticate the user and/or the client compute device 139 based on the login credentials and/or other similar authenticating parameters, at 604. Based on authenticating the user at 604, the IdP server 101 sends an authentication response, at 607, to the SP server 115 indicating whether the IdP server 101 was able to successfully authenticate the user.

In an another instance, the process of authenticating the client compute device 139 can be performed by the SP server 115 without sending an authentication request to the IdP server 101. In such an instance, the SP server 115 authenticates the client compute device 139 by directly receiving authentication data with one or more authentication parameters from the client compute device 139 or from another source (e.g., the distributed consensus database) in the access request 601. The SP server 115 can use this authentication data to authenticate the client compute device 139.

The client compute device risk information assessment 620 includes identifying and storing risk assessment information, at 610; achieving consensus in the distributed consensus database, at 611; analysis of risk assessment information to determine an access decision, at 615; and storing the indication of access decision in the distributed consensus database instance, at 617. These processes will be discussed further below.

In one instance, the SP server 127 identifies the risk assessment information associated with client compute device 139 (or a user of the client compute device 139) and stores the risk assessment information at the distributed consensus database instance 137, at 610. The SP server 127 can identify risk assessment information related to the client compute device (e.g. client compute device 139) using one or combination of methods described herein. As an example, the risk assessment information can be indications of observations by the SP server 127 regarding client compute device 139 (or a user of the client compute device 139). For example, the risk assessment information can include information indicative of a malicious action by the client compute device 139 at the SP server 127, an indication that access to the SP sever 127 by the client compute device 139 has been granted, an indication that access to the SP sever 127 by the client compute device 139 has been revoked, a risk assessment score calculated by the SP server 127, and/or any other suitable data used to determine a risk assessment value or score as described herein.

After the SP server 127 stores the risk assessment information in its distributed consensus database instance 137, consensus can be achieved in the distributed consensus database, at 611. Specifically, as described above, the transactions to manipulate data in a local instance of a distributed consensus database can be automatically replicated, propagated or synchronized among other instances of the database, as described in further detail above. Thus, the risk assessment information stored in distributed consensus database instance 137 at 610 can be replicated, propagated or synchronized to the other instances of the distributed consensus database (including distributed consensus database instance 125 at SP server 115). This allows the SP server 115 to use the latest (and/or most relevant) risk information about the client compute device 139 from the other SP servers (including SP server 127). In another instance, the SP server 115 can also obtain at least partial risk assessment information from server(s) connected out of the network and/or from public server(s) (not shown in FIG. 6).

At 615, the SP server 115 calculates a risk assessment value for the client compute device 139 based on the risk assessment information replicated to the distributed consensus database instance 125 at 611. The SP server 115 can calculate the risk assessment value using any suitable method and/or methodology as described herein.

In some instances, the SP server 115 uses the risk assessment information in one or more probability, statistical and/or machine learning methods to determine a risk assessment value associated with the client compute device 139. In yet another instance, the SP server 115 can calculate the risk assessment value based on the discovery of knowledge, data patterns, previous relationships with other service providers, and/or inference analysis of one or more records in the distributed consensus database (e.g., as gathered and/or calculated by the SP servers 115, 127 and/or other third-party devices). In addition or alternatively, the risk assessment value associated with the client compute device 139 can be determined from historical data and/or tracked user behavioral data collected by one or more SP servers and/or IdP servers (or other third-party compute devices) having an instance of the distributed consensus database.

In some instances, the SP server 115 can periodically monitor the records in the distributed consensus database instance 125 to obtain updated risk assessment information. Thus, the risk assessment information at the SP server 115 can be periodically and/or sporadically updated based on consensus being periodically and/or sporadically achieved in the distributed consensus database. Moreover, the SP server can update risk information in the distributed consensus database instance 125 based on interactions between SP server 115 and the client compute device 139 (or the user of the client compute device 139.

At 616, the SP server 115 can determine an access decision associated with the client compute device 139 based on the risk assessment value. For example, the SP server 115 can compare the risk assessment value to a criterion and/or threshold. If the risk assessment value meets the criterion, the SP server 115 can determine to grant access to the client compute device 139. If, however, the risk assessment value does not meet the criterion, the SP server can deny access to the client compute device 139.

In some instances, the SP server 115 can use a threshold and/or criterion common to each of the SP servers and/or IdP servers having an instance of the distributed consensus database. In other instances, the SP server 115 can define a criterion and/or threshold value for providing access to the client compute device 139 (or user) specific to the SP server 115. In such instances, each SP server and/or IdP server can have a different criterion and/or threshold to allow access to the client compute device 139. Accordingly, the SP server 115 can manage access of the services for client compute device 139 based on its defined threshold and the calculated risk assessment value. The SP server 115 can restrict access to the client compute device 139 and/or user if the present risk assessment value fails to meet the defined criterion and/or threshold. If, however, the calculated risk assessment value satisfies the defined criterion and/or threshold, the SP server 115 can provide at least partial access to client compute device 139 (or user).

In some instances, SP servers can define the criterion and/or threshold based on the service provided by that SP server. For example, a threshold for a social media based SP server can have lower threshold than a financial transaction based SP server. Similarly stated, the financial transaction based SP server can have less tolerance of risk than the social media based SP server.

In some instances, while analyzing the risk assessment information, the SP server 115 can weight information based on the source of information. For example, based on service industry of the SP server, the SP server 115 can assign different weights to the risk assessment information obtained from different instances of the distributed consensus databases. For example, the weights assigned to SP server related to finance industry is higher as compared to SP server related to social media industry. Thus, during the calculation of the risk assessment value, the risk assessment information contributed by SP server related to finance industry will have higher weight (or significance) as compared to the risk assessment information contributed by SP server related to social media industry. The access decision will vary based on the weightage of the service industry for the SP server.

The SP server 115 can store an indication of the access decision in the instance of the distributed consensus database 125, at 617. After consensus is subsequently derived in the distributed database, the stored indication of the access decision can be accessed by other SP servers (e.g. SP server 127). This allows such other SP servers to use the access decision made by SP server 115 as a factor in determining access decisions specific to such other SP servers. This also allows the SP servers to exchange current risk information associated with a particular client compute device 139 (and/or user). If, for example, SP server 115 identifies malicious behavior associated with client compute device 139 (e.g., as indicated by an IP address, geographical location, MAC address, etc.), then SP server 115 can add an entry to the distributed consensus database associated with the identified risk. Other devices can then review this risk and act accordingly (e.g., deny access, revoke access, allow access, reduce a level of access, etc.). For another example, devices can exchange any other suitable information, such as, for example, transaction information, preference information associated with specific users and/or devices, and/or the like.

In some other instances, the SP server 115 can restrict access to the client compute device 139 based on the risk information in the distributed consensus database. For example, an SP server serving as a public video-sharing platform may impose at least some access restriction(s) on the contents to a client compute device 139 based on the risk information in the distributed consensus database. These access restrictions may potentially vary for different client compute device(s) and/or user based on the information present in the distributed consensus database.

The SP server 115 sends the access response 619 to the client compute device 139. The access response 619 is used to inform the client compute device 139 (or user) about the decision for accessing the services provided by the SP server 115. The access response indicates the access to the offered services by SP server 115 has be approved, at least partially approved, and/or denied.

In some instances, based on the risk assessment information associated with different client compute devices, an SP server can grant different levels of access to different client compute devices. For example, if the risk assessment information associated with a first client compute device indicates potential malicious activity by the first client compute device, the SP server can grant read only access to a resource at the SP server. In such an example, if the risk assessment information associated with a second client compute device indicates no potential malicious activity by the second client compute device, the SP server can grant both read and write access to a resource at the SP server.

While shown and described with respect to FIG. 6 as having both a client compute device authentication process 605 and a client compute device risk information assessment process 620, in other instances the SP server 115 can provide access to client compute device 139 without performing the client compute device authentication process 605. For example, an SP server can determine an access decision for a client compute device based on information and/or data in the distributed consensus database and without authenticating a user based on user supplied information. As one example, an SP associated with an online retail store can determine whether to provide access to its retail services to the client compute device as a guest based on the information in the distributed consensus database associated with that client compute device. In such instances, the client compute device 139 can still send the access request to 601 to trigger the client compute device risk information assessment process 620.

While method 600 illustrates exchanging risk assessment information in the context of an SP server determining an access decision, in other instances the SP servers and/or IdP servers can share risk assessment information in any other suitable context. SP servers can share the risk assessment information, for example, for supervising and information collection purposes by a law enforcement agency, to prevent fraudulent commercial transactions, to aid in identification of identity theft and/or the like. For example, during a financial transaction, a first SP server can share risk assessment information associated with fraudulent transactions associated with the client compute device with a second SP server. Based on the shared risk assessment information, the second SP server can decide whether to continue with the transaction based on the risk assessment information.

In some instances, an SP server can define a risk assessment value and/or determine an access decision based on a set of SP servers and/or IdP servers verifying risk assessment information associated with a client compute device. For example, if a predetermined number of SP servers and/or IdP servers indicate that the client compute device is malicious, another SP can revoke access to the client compute device. In other instances, any other decision can be taken based on a predetermined number of SP servers and/or IdP servers verifying the information and/or action.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

What is claimed is:

1. An apparatus, comprising:
an instance of a distributed database at a first service provider server configured to be included in a plurality of service provider servers that implement the distributed database via a network operatively coupled to the plurality of service provider servers; and
a processor of the first service provider server, the processor operatively coupled to the instance of the distributed database at the first service provider server, the processor configured to grant a client compute device access to a resource at a first time,
the processor configured to identify authentication information associated with the client compute device and in the instance of the distributed database at the first service provider server at a second time after the first time in response to the authentication information being provided to an instance of the distributed database at a second service provider server from the plurality of service provider servers and based on a status associated with the client compute device at the second service provider server,
the processor configured to revoke access to the resource by the client compute device based on the authentication information.

2. The apparatus of claim 1, wherein the processor is configured to revoke access to the resource by the client compute device based on the authentication information meeting a criterion associated with a predetermined risk profile of the resource.

3. The apparatus of claim 1, wherein the authentication information is indicative of a malicious action by the client compute device at the second service provider server.

4. The apparatus of claim 1, wherein the authentication information is a risk score associated with the client compute device and calculated based on information regarding the client compute device provided by the plurality of service provider servers.

5. The apparatus of claim 1, wherein the processor is configured to store in the instance of the distributed database at the first service provider server an indication that access to the resource by the client compute device was revoked.

6. The apparatus of claim 1, wherein the processor is configured to grant the client compute device access to the resource at the first time based on receiving at least one authentication credential associated with a user of the client compute device.

7. The apparatus of claim 1, wherein the processor is configured to revoke access by the client compute device to the resource based on a number of service provider servers from the plurality of service provider servers verifying the authentication information meeting a criterion.

8. The apparatus of claim 1, wherein the authentication information is an indication that an identity token has been revoked by an identity provider server.

9. A non-transitory processor-readable medium storing code representing instructions to be executed by a processor, the code comprising code to cause the processor to:
receive, from a client compute device and at a server, a request to access a resource, the request including an identifier associated with the client compute device;
access risk information associated with the client compute device from an instance of a distributed database at the server using the identifier, the risk information provided to the distributed database by a plurality of compute devices, each compute device from the plurality of compute devices implementing a different instance of the distributed database;
analyze the risk information to identify an access decision; and
grant to the client compute device a level of access to the resource based on the access decision.

10. The non-transitory processor-readable medium of claim 9, wherein the code to cause the processor to analyze includes code to cause the processor to analyze the risk information and a type of requested access to the resource to identify the access decision.

11. The non-transitory processor-readable medium of claim 9, further comprising code to cause the processor to:
record information regarding an interaction between the client compute device and the server; and
store the information in the instance of the distributed database at the server such that each compute device from the plurality of compute devices can access the information via the distributed database.

12. The non-transitory processor-readable medium of claim 9, further comprising code to cause the processor to:
store an indication of the access decision in the instance of the distributed database at the server such that each compute device from the plurality of compute devices can access the indication of the access decision via the distributed database.

13. The non-transitory processor-readable medium of claim 9, wherein the server is an identity provider server, each compute device from the plurality of compute devices is associated with a different service provider from a plurality of service providers configured to authenticate the client compute device based on the access decision.

14. The non-transitory processor-readable medium of claim 9, wherein the level of access is a first level of access and the client compute device is a first client compute device, the code further comprising code to cause the processor to:
access risk information associated with a second client compute device from the instance of the distributed database at the server; and
grant, to the second client compute device and based on the authentication information associated with the second client compute device, a second level of access to the resource different from the first level of access to the resource.

15. The non-transitory processor-readable medium of claim 9, further comprising code to cause the processor to:
define an authentication token based on the access decision; and
store the authentication token in the instance of the distributed database at the server such that each compute device from the plurality of compute devices can use the authentication token to grant the client compute device access to that compute device from the plurality of compute devices.

16. The non-transitory processor-readable medium of claim 9, wherein the request to access the resource includes at least one authentication credential associated with a user of the client compute device.

17. An apparatus, comprising:
an instance of a distributed database at a first server configured to be included in a plurality of servers that implement the distributed database via a network operatively coupled to the plurality of servers; and
a processor of the first server, the processor operatively coupled to the instance of the distributed database at the first server,
the processor configured to identify an action potentially indicative of a risk posed by a client compute device, the processor configured to store an indication of the action in the instance of the distributed database at the first server such that a second server from the plurality of servers can access the indication of the action from an instance of the distributed database at the second server after convergence of the distributed database and can make an authentication decision at the second server and for the client compute device based at least in part of the indication of the action.

18. The apparatus of claim 17, wherein:
the processor is configured to deny access of the client compute device to a resource at the first server based on the action,
the authentication decision is to allow the client compute device to access a resource at the second server.

19. The apparatus of claim 17, wherein the authentication decision is to deny the client compute device access to a resource at the second server.

20. The apparatus of claim 17, wherein the processor is configured to revoke access to a resource at the first server based on a number of servers from the plurality of servers verifying the action meets a criterion.
